(19) United States
(12) Patent Application Publication
(10) Pub. No.: US 2010/0259317 A1
(43) Pub. Date: Oct. 14, 2010

(54) HIGH-OUTPUT-IMPEDANCE CURRENT MIRROR

(75) Inventors: NAN-KU LU, CHUNG LI (TW); CHUN-CHIEH CHEN, CHUNG LI (TW); YI-JHIH ZENG, CHUNG LI (TW); SHIAU-TZA GU, CHUNG LI (TW)

Correspondence Address: ROSENBERG, KLEIN & LEE, 3458 ELLICOTT CENTER DRIVE-SUITE 101, ELLICOTT CITY, MD, 21043, US

(73) Assignee: CHUNG YUAN CHRISTIAN UNIVERSITY, CHUNG LI (TW)

(21) Appl. No.: 12/505,807

(22) Filed: Jul. 20, 2009

(30) Foreign Application Priority Data
Apr. 14, 2009 (TW) 098112292

(51) Int. Cl. G05F 1/10

(52) U.S. Cl. 327/543

(57) ABSTRACT

A current mirror with high output impedance for ensuring high accuracy current output comprises a first calibration circuit, a second calibration, a base circuit, a base current mirror, and an output circuit. The first calibration circuit further comprises plural MOS transistors and a first voltage. The second calibration circuit coupled with the first calibration circuit further comprises plural MOS transistors to calibrate the first calibration circuit. The base current mirror comprising two MOS transistors is coupled with both the first and the second calibration circuits via the base circuit. The output circuit with plural MOS transistors is coupled with the base circuit and the first calibration circuit. Upon an input current flows into the current mirror, the current mirror generates an output current which is several times in intensity than that of the input current.

This application claims the benefit of Taiwan Patent Application Serial No. 098112292, filed Apr. 14, 2009, the subject matter of which is incorporated herein by reference.

### BACKGROUND OF THE INVENTION

(1) Field of the Invention

The invention is associated with a kind of current mirrors, especially with a current mirror having high-output-impedance and enhanced accuracy in current output.

(2) Description of the Prior Art

It is well known in the art that one of the shortcoming in analog communication is its vulnerability in interference, no matter whether the analog signal is originated from an internet, an FM broadcast, a wireless communication, or any the like. On the other hand, the digital communication provides a solution to overcome the aforesaid shortcomings. Further, communication via digital signals can provide a better signal-to-noise (S/N) ratio over the analog communication. Also, the digital signal can be easily compressed and de-compressed, such that the volume of the transmissible data information by the digital communication can be much larger than that by the analog communication. Hence, it is the reason why plenty of modern 3C products, such as computers, communication systems, household appliances, satellite communications, satellite TVs and so on, are chosen to be digitalized.

In the art, the Digital/Analog (D/A) or Analog/Digital (A/D) converter who provides signal conversion between the analog signal and the digital signal plays an important role in data communication. The operational precision of the D/A or A/D converter can be ensured by a higher output impedance and a higher accuracy of output currents. Conventionally, such a task in enhancing the operational precision can be achieved by including a current mirror to the D/A or A/D converter.

Please refer to FIG. 1, which is a typical current mirror. As shown, the current mirror has plural MOS transistors wherein PMOS MP1˜MP4 are used to make the respective input currents to be ideal currents. NMOS MN7 connected amid to NMOS MN3, PMOS MP4, NMOS MN5, and NMOS MN8 so as to increase output impedance generates a negative feedback circuit for lowering possible transmission errors. It is noted that drain-gate voltages of MP2 and MP4 are not certainly the same, so that I_{M6} is not certainly equal to I_{M8}, and thereby this typical current mirror cannot achieve the high-output-impedance ideally.

The effort of this invention is to provide an improved current mirror based on the aforesaid design who can meet the requirements in high-output-impedance and accuracy of output currents.

### SUMMARY OF THE INVENTION

Accordingly, it is an object of the present invention to provide a high-output-impedance circuit mirror, which can increase output impedance and enhance accuracy of output currents, further by which the operational precision of D/A or A/D converters can be ensured.

In the present invention, the high-output-impedance current mirror can include a first calibration circuit, a second calibration circuit, a base current mirror and an output circuit. An input current flows into the high-output-impedance current mirror to generate the output current, which is several-time larger in intensity than the input current.

The first calibration circuit can further include plural MOS transistors and a first voltage.

The second calibration circuit coupled with the first calibration circuit can comprise plural MOS transistors to calibrate the first voltage.

The base current mirror comprising two MOS transistors is coupled with the first calibration circuit and the second calibration circuit through a base circuit. The base circuit can further include plural MOS transistors to enhance the output impedance of the high-output-impedance current mirror.

The output circuit comprising plural MOS transistors is coupled with the base circuit and the first calibration circuit.

In the present invention, the first calibration circuit can include a first PMOS transistor, a second PMOS transistor, a third PMOS transistor, and a fourth PMOS transistor. The source of the first PMOS transistor is connected to the source of the third PMOS transistor, while the gate of the first PMOS transistor is connected to the gate of the third PMOS transistor. The drain of the first PMOS transistor is connected to its own gate, and the drain of the second PMOS transistor is also connected to its own gate. The source of the second PMOS transistor is coupled with the drain of the first PMOS transistor. The drain of the third PMOS transistor is coupled with the source of the fourth PMOS transistor.

In the present invention, the second calibration circuit can further include a fifth PMOS transistor, a sixth PMOS transistor and a seventh NMOS transistor. The drain of the fifth PMOS transistor is coupled with the source of the sixth PMOS transistor. The drain of the sixth PMOS transistor is coupled with the drain of the seventh NMOS transistor. The source of the seventh NMOS transistor is grounded.

In the present invention, the base current mirror can further include a first NMOS transistor and a fifth NMOS transistor. The gate of the first NMOS transistor is coupled with the gate of the fifth NMOS transistor. The gate of the first NMOS transistor is self coupled with its own drain. Both the source of first NMOS transistor and the source of the fifth NMOS transistor are grounded.

In one embodiment of the present invention, the base circuit can include three MOS transistors whose gates are all coupled together.

In one embodiment of the present invention, the base circuit can include two MOS transistors whose gates are all coupled together.

In the present invention, the output circuit can include four MOS transistors; a second NMOS transistor, a third NMOS transistor, an eighth NMOS transistor and a ninth NMOS transistor. The gate of the second NMOS transistor is coupled with the drain of the eighth NMOS transistor. The source of the eighth NMOS transistor is coupled with the drain of the ninth NMOS transistor. The source of the ninth NMOS transistor is grounded. The source of the second NMOS transistor source is coupled with both the gate of the ninth NMOS transistor and the drain of the third NMOS transistor. The source of the third NMOS transistor is grounded.

In one embodiment of the present invention, the first calibration circuit can further include a second PMOS transistor and a fourth PMOS transistor. A second voltage exists between the source and the gate of the second PMOS transistor, while a third voltage exists between the source and the gate of the fourth PMOS transistor. The aforesaid first voltage of the first calibration circuit can be defined as the difference between the second voltage and the third voltage.

All these objects are achieved by the high-output-impedance circuit mirror described below.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is a diagram of a typical current mirror;

FIG. 2 is a diagram of a first embodiment of the high-output-impedance current mirror in accordance with the present invention; and

FIG. 3 is a diagram of a second embodiment of the high-output-impedance current mirror in accordance with the present invention.

### DETAILED DESCRIPTION OF THE PREFERRED EMBODIMENT

The invented current mirror can be used in computers, communication systems, household appliances, various 3C products, and so on.

The current mirror with high-output-impedance in accordance with the present invention in mainly composed by a number of PMOS (p-type metal-oxide-semiconductor) transistors and NMOS (n-type metal-oxide-semiconductor) transistors.

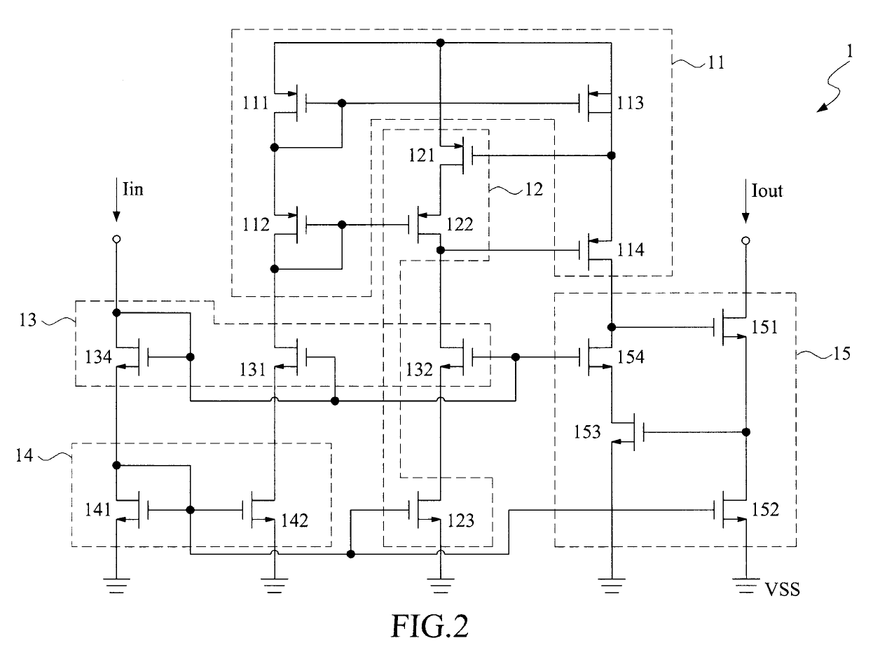

Please refer to FIG. 2 which is a schematic drawing of a first embodiment of the high-output-impedance current mirror 1 in accordance with the present invention.

The current mirror 1 consists of a first calibration circuit 11, a second calibration circuit 12, a base circuit 13, a base current mirror 14, and an output circuit 15. An input current Iin flows into the current mirror 1 from the base circuit 13, and then an output current lout flows out of the current mirror 1 from the output circuit 15.

The first calibration circuit 11 has four PMOS transistors which are a first PMOS transistor 111, a second PMOS transistor 112, a third PMOS transistor 113 and a fourth PMOS transistor 114. The drain and the gate of the first PMOS transistor 111 are coupled. Likewise, the drain and the gate of the second PMOS transistor 112 are coupled. The sources of the first PMOS transistor 111 and the third PMOS transistor 113 are coupled.

The gates of the first PMOS transistor 111 and the third PMOS transistor 113 are coupled. The drain of the first PMOS transistor 111 is coupled with the source of the second PMOS transistor 112. The drain of the third PMOS transistor 113 is coupled with the source of the fourth PMOS transistor 114. The first calibration circuit 11 makes the input currents Iin approach the reference current.

The second calibration circuit comprises two PMOS transistors and one NMOS transistor; a fifth PMOS transistor 121, a sixth PMOS transistor 122 and a seventh NMOS transistor 123. The sources of the fifth PMOS transistor 121 and the first PMOS transistor 111 are coupled. The gate of the fifth PMOS transistor 121 is coupled with the drain of the third PMOS transistor 113. The drain of the fifth PMOS transistor 121 is coupled with the source of the sixth PMOS transistor 122. The gates of the sixth PMOS transistor 122 and the second PMOS transistor 112 are coupled together. The drain of the sixth PMOS transistor 122 is coupled with the gate of the fourth PMOS transistor 114. The seventh NMOS transistor 123 is connected to the ground.

Within the first calibration circuit 11, there is a second voltage between the source of the second PMOS transistor 112 and the gate of the second PMOS transistor 112, and a third voltage between the source of the fourth PMOS transistor 114 and the gate of the fourth PMOS transistor 114. The first voltage is defined as the difference of the second voltage and the third voltage. Ideally, the first voltage should be zero, such that the second voltage can be equal to the third voltage. However, in practice, the second voltage is not equal to the third voltage, from which the first voltage is no longer in an ideal zero-voltage state. Therefore, the second calibration circuit 12 is introduced to calibrate the first voltage close to the ideal zero value. Upon such an arrangement, the output current of the whole circuit mirror can be closer to the reference current.

The base circuit 13 consists of three NMOS transistors which are a fourth NMOS transistor 131, a sixth NMOS transistor 132 and a tenth NMOS transistor 133. The gates of these three NMOS transistors are all coupled together. The drains of the fourth NMOS transistor 131 and the second PMOS transistor 112 are coupled. The drain of the sixth NMOS transistor 132 is coupled with the gate of the fourth PMOS transistor 114. The source of the sixth NMOS transistor 132 is coupled with the drain of seventh NMOS transistor 123. The drain and the gate of the tenth NMOS transistor 133 are coupled together. The input current Iin flows in from the tenth NMOS transistor 133.

The base current mirror 14 has two NMOS transistors; a first NMOS transistor 141 and a fifth NMOS transistor 142. The gate and the drain of the first NMOS transistor 141 are coupled. The gate of the first NMOS transistor 141 is also coupled with the gates of the seventh NMOS transistor 123 and the fifth NMOS transistor 142. The drain of the first NMOS transistor 141 is coupled with the source of the tenth NMOS transistor 133. The drain of the fifth NMOS transistor 142 is coupled with the source of the fourth NMOS transistor 131. The sources of the first NMOS transistor 141 and the fifth NMOS transistor 142 are connected to the ground.

The base current mirror 14, the tenth NMOS transistor 133 and the fourth NMOS transistor 131 are coupled so as to form a so-called cascade current mirror for increasing the overall output impedance of the present current high-output-impedance mirror.

The output circuit 15 consists of four NMOS transistors; a second NMOS transistor 151, a third NMOS transistor 152, a eighth NMOS transistor 154, and a ninth NMOS transistor 153. The gate of the second NMOS transistor 151 is coupled with the drain of the fourth PMOS transistor 114. The source of the second NMOS transistor 151 is coupled with the drain of the third NMOS transistor 152. The gates of the third NMOS transistor 152 and the first NMOS transistor 141 are coupled together. The source of the third NMOS transistor 152 is connected to the ground. The source of the eighth NMOS transistor 154 is coupled with the drain of the ninth NMOS transistor 153. The drains of the eighth NMOS transistor 154 and the fourth PMOS transistor 114 are coupled together. The gates of the eighth NMOS transistor 154 and the sixth NMOS transistor 132 are coupled together. The gate of the ninth NMOS transistor 153 is coupled with the source of the second NMOS transistor 151. The source of the ninth NMOS transistor 153 is connected to the ground.

In the output circuit 15, the second NOMS transistor 151, the ninth NMOS transistor 153 and the eighth NMOS transistor 154 are integrated to form a feedback circuit which can stabilize the gate voltage of the second NMOS transistor 151. If the gate voltage of the second NMOS transistor 151 is increased by some unexpected factors, the source voltage of the second NMOS transistor 151 can be increased to maintain a constant output current. Because of the source of the second NMOS transistor 151 being coupled with the gate of the ninth NMOS transistor 153, as the gate voltage of the ninth NMOS transistor 153 increases, the drain voltage of the ninth NMOS transistor 153 would decrease in response to the constant current flowing into the drain of the ninth NMOS transistor 153. Consequently, the drain voltage of the eighth NMOS transistor 154 decreases as well. Further, for the drain of the NMOS transistor 154 is connected to the gate of the second NMOS transistor 151, the decreasing in the drain voltage of the eighth NMOS 154 will lead to a decrease in the drain voltage of the second NMOS transistor 151. Upon such an arrangement, the voltage of the high-output-impedance current mirror can be maintained substantially to a constant value.

Except for the above cascade current mirror, the eighth NMOS transistor 154 is also provided with a functionality of increasing output impedance so as to ensure a high output impedance to the present current mirror 1.

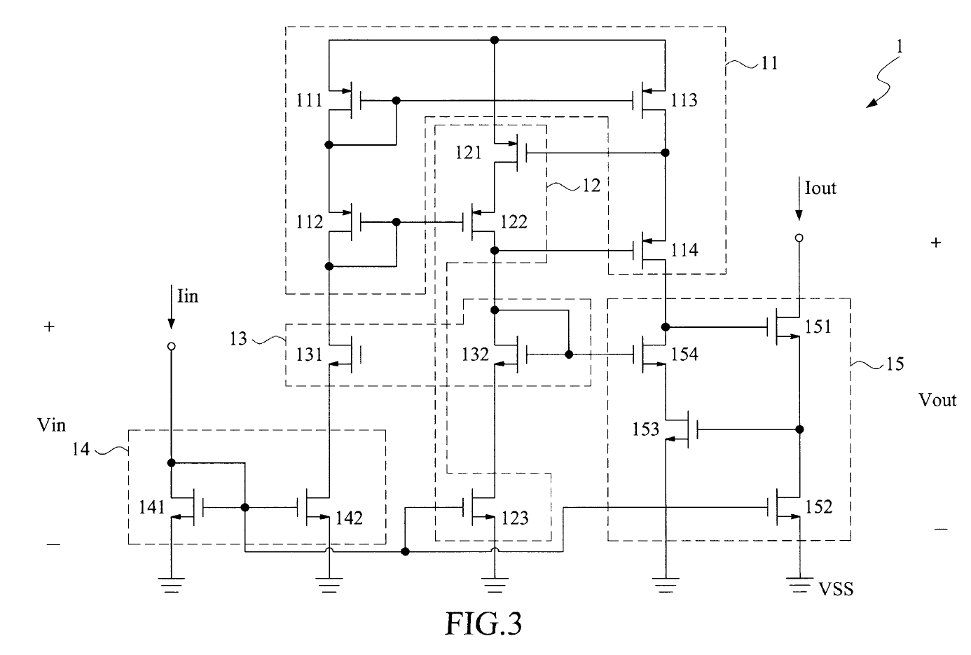

Please refer to FIG. 3, which is a second embodiment of the high-output-impedance current mirror in accordance with the present invention. By compared to the first embodiment of FIG. 2, the base circuit 13 of the second embodiment includes only two transistors, the fourth NMOS transistor 131 and the sixth NMOS transistor 132. The sixth NMOS 132 transistor's drain and gate are coupled together. Because the base current mirror 14 of the second embodiment is no more a cascade current mirror, the output impedance of the second embodiment is lower than that of the first embodiment.

Please refer to Table 1 and Table 2. Table 1 is a simulation result under the Spice model: TT. The Vin shown in the second column means the input voltage, and the Vout shown in the third column means the output voltage. As shown, by introducing the present invention, the output impedance, either in the first embodiment or in the second embodiment, can be greatly hiked.

On the other hand, Table 2 is a simulation result under the Spice model: SF. It is obvious to see that the present invention do increase the output impedance of the current mirror.

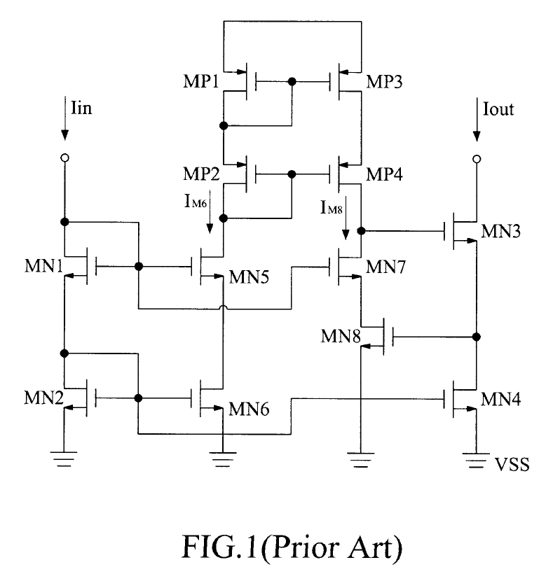

TABLE 1

| | | | Output |
|---|---|---|---|
| | 800 mV (Vin) | 1.5 V (Vout) | Impedance |
| Current mirror in | 9.999995561 uA | 9.9999995622 uA | 174.956 GΩ |
| FIG. 1 | | | |
| (Conventional) | | | |
| Current mirror in | 9.9999998084 uA | 10.000000514 uA | 997.150 GΩ |
| FIG. 2 (1^{st} | | | |
| embodiment) | | | |
| Current mirror in | 9.9999998143 uA | 10.00000052 uA | 991.501 GΩ |
| FIG. 3 (2^{nd} | | | |
| embodiment) | | | |

TABLE 2

| | | | Output |
|---|---|---|---|
| | 800 mV | 1.5 V | Impedance |
| Current mirror in | 9.9999968883 uA | 10.000005017 uA | 86.185 GΩ |
| FIG. 1 | | | |
| (Conventional) | | | |
| Current mirror in | 9.9999998356 uA | 9.9999999008 uA | 10769.230 GΩ |
| FIG. 2 (1^{st} | | | |
| embodiment) | | | |
| Current mirror in | 9.9999998583 uA | 9.9999999222 uA | 10937.500 GΩ |
| FIG. 3 (2^{nd} | | | |
| embodiment) | | | |

Therefore, the current mirror of the invention can effectively increase its own output impedance, such that the operational precision of D/A or A/D converters adopting the current mirror of the present invention can be ensured.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A high-output-impedance current mirror, having an input current and an output current times in intensity of the input current, comprising:
a first calibration circuit comprising plural MOS transistors and a first voltage;
a second calibration circuit coupling with the first calibration circuit, comprising plural MOS transistors to calibrate the first voltage;
a base current mirror comprising two MOS transistors, coupling with the first calibration circuit and the second calibration circuit through a base circuit, the base circuit further comprising plural MOS transistors; and
an output circuit, coupling with the base circuit and the first calibration circuit, comprising plural MOS transistors.

2. The current mirror according to claim 1, wherein said first calibration circuit further includes a first PMOS transistor, a second PMOS transistor, a third PMOS transistor and a fourth PMOS transistor; a drain and a gate of the first PMOS transistor 111 being coupled together, a drain and a gate of the second PMOS transistor being coupled together, a source of the first PMOS transistor being coupling with a source of the third PMOS transistor.

3. The current mirror according to claim 1, wherein said second calibration circuit further includes a fifth PMOS transistor, a sixth PMOS transistor and a seventh PMOS transistor; a drain of the fifth PMOS transistor being coupled with a source of the sixth PMOS transistor, a drain of the sixth PMOS transistor being coupled with a drain of the seventh NMOS transistor, a source of the seventh NMOS transistor being grounding.

4. The current mirror according to claim 1, wherein said base current mirror further includes a first NMOS transistor and a fifth NMOS transistor; a gate of the first NMOS transistor being coupled with a gate of the fifth NMOS transistor, the gate of the first NMOS transistor being coupled with a drain of the same first NMOS transistor, both a source of the first NMOS transistor and a source of the fifth NMOS transistor being connected to a ground.

5. The current mirror according to claim 1, wherein said base circuit further includes three MOS transistors whose gates are all coupled together.

6. The current mirror according to claim 1, wherein said base circuit further includes two MOS transistors whose gates are all coupled together.

7. The current mirror according to claim 1, wherein said output circuit further includes a second NMOS transistor, a third NMOS transistor, an eighth NMOS transistor and a ninth NMOS transistor four MOS transistors; a gate of the second NMOS transistor being coupled with a drain of the eighth NMOS transistor, a source of the eighth NMOS transistor being coupled with a drain of the ninth NMOS transistor, a source of the ninth NMOS transistor being grounded, a source of the second NMOS transistor being coupled with both a gate of the ninth NMOS transistor and a drain of the third NMOS, a source of the third NMOS transistor being grounded.

8. The current mirror according to claim 1, wherein said first calibration circuit further has a second PMOS transistor and a fourth PMOS transistor, a second voltage existing between a source and a gate of the second PMOS transistor, a third voltage existing between a source and a gate of the fourth GMOS transistor, the first voltage being defined as a difference between the second voltage and the third voltage.
